(19) United States
(12) Patent Application Publication
(10) Pub. No.: US 2015/0073338 A1
(43) Pub. Date: Mar. 12, 2015

(54) ENTERAL FEEDING PUMP WITH ACCELERATION SENSOR AND RELATED METHODS THEREFOR

(71) Applicant: Covidien LP, Mansfield, MA (US)

(72) Inventors: Gary Waldhoff, St. Charles, MO (US); Robert Gaines, Lake Saint Louis, MO (US); John Holste, Hamburg, IL (US)

(21) Appl. No.: 14/482,304

(22) Filed: Sep. 10, 2014

Related U.S. Application Data
(60) Provisional application No. 61/875,929, filed on Sep. 10, 2013.

(51) Int. Cl. A61J 15/00

(52) U.S. Cl. CPC A61J 15/0026; A61J 15/0003; A61J 2015/0076; A61J 2015/0084; A61J 2015/0088
USPC 604/66; 604/67; 29/825

(57) ABSTRACT

An enteral feeding pump for mounting a pump set for enteral delivery of fluid through the pump set to a subject including a housing capable of receiving at least a portion of a pump set. A pumping device contacts the pump set when the pump set is received by the housing so the pumping device acts on the pump set to produce fluid flow in the pump set for enteral delivery of fluid to a subject. A sensor is connected to the housing for sensing acceleration of at least a portion of the housing caused by an impact to the housing and producing a signal in response to the sensed acceleration. A control circuit in the housing is programmed to perform an operation after the sensor produces a predetermined sequence of signals.

### CROSS-REFERENCE TO RELATED APPLICATION

This application is a non-provisional application of and claims the benefit of priority to U.S. Patent Application No. 61/875,929, titled ENTERAL FEEDING PUMP WITH ACCELERATION SENSOR, filed on Sep. 10, 2013, the entirety of which is incorporated herein by reference for all purposes.

### FIELD

This disclosure relates to a pump used to deliver fluids to a subject by way of a pump set, and more particularly to an enteral feeding pump having a sensor for detecting movement of the pump.

### BACKGROUND

Administering fluids containing medicine or nutrients to a patient is well known in the art. Typically, fluid is delivered to the patient by a pump set loaded on a flow control apparatus, such as an enteral pump, which delivers fluid to the patient at a controlled delivery rate. An enteral feeding pump may comprise a housing enclosing a rotor or the like operatively connected to at least one motor by a gearbox. The rotor may drive fluid through tubing of the pump set by peristaltic action caused by rotation of the rotor driven by the motor. The motor may be operatively connected to a rotatable shaft connected to the rotor, which progressively compresses the tubing to drive the fluid at a controlled rate through the pump set. The pump set may have a type of valve mechanism for permitting or preventing fluid flow through the pump set. A controller may operate the motor or motors used to drive the rotor and, in some cases, control fluid flow as by operation of the valve mechanism.

During operation, the manner in which the pump is handled and the environment in which the pump is used can negatively impact the proper delivery of fluid to the patient. Thus, it may be beneficial to monitor movement of the pump during operation to assist a technician or clinician in assessing the condition of the pump. Further, knowledge of pump movement and impact can be used to perform certain pump operations to make the pump adaptive to in use conditions and more user friendly.

### SUMMARY

There is disclosed an enteral feeding pump for mounting a pump set for enteral delivery of fluid through the pump set to a subject, the enteral feeding pump comprising a housing capable of receiving at least a portion of the pump set, a display in the housing for displaying information about the pump, a pumping device contacting the pump set when the pump set is received by the housing so the pumping device acts on the pump set to produce fluid flow in the pump set, a sensor connected to the housing for sensing an acceleration of at least a portion of the housing and producing a signal in response to the sensed acceleration, and a control circuit configured to receive the signal and control operation of the pump in response to the signal. The control circuit is configured to identify the signal as corresponding to a predetermined event and control operation of the pump with the predetermined event. The pump further comprises an illumination source. The control circuit is configured to identify the signal as a light-activating signal, and wherein operation of the pump comprises energizing the illumination source upon identification of the light-activating signal. The control circuit is further configured to interpret a second signal produced by the sensor from a second acceleration as a light-deactivating signal, and wherein operation of the pump further comprises de-energizing the illumination source upon identification of the light-deactivating signal. The control circuit is further configured to de-energize the illumination source after a predetermined period, after energizing the illumination source. The illumination source is configured to illuminate at least a portion of the display. The control circuit is further configured to suspend operation of the pump if a magnitude of the acceleration is above a predetermined threshold. The pump control circuit includes a processor and a memory having stored therein a representative signal indicative of acceleration as a critical impact. The processor is configured to perform instructions that compare the received signal to the representative signal and identify the acceleration as a critical impact, and, upon identification of the critical impact, provide an indication of an operational error. The control circuit is configured to identify the signal as corresponding to ambulatory activity, and to control operation of the pump based on a duration of the ambulatory activity. The control circuit is configured to identify the signal as corresponding to an orientation of the pump, and to control operation of the display based on the orientation of the pump.

There is disclosed a method of fabricating a pump having a housing configured for mounting a pump set thereonto for enteral delivery of fluid through the pump set to a subject, and a display for indicating information about the pump. The method comprises connecting a sensor to the housing for sensing an acceleration of at least a portion of the housing and producing a signal in response to the sensed acceleration, connecting a control circuit to the sensor to receive the signal, wherein the control circuit is configured to the control operation of the pump based on the received signal. The sensor is typically an accelerometer. The control circuit is configured to identify whether the signal corresponds to an illumination command, and the control circuit is further configured to illuminate at least a portion of the display upon identification of the illumination command. The control circuit is configured to identify whether the signal corresponds to a critical impact. The control circuit is configured to suspend operation of the pump upon identification of the critical impact. The control circuit is configured to identify whether the signal corresponds to ambulatory activity, and to regulate operation of the pump based on a duration of the ambulatory activity. The control circuit is configured to identify the signal as corresponding to an orientation of the pump, and to control operation of the display based on the orientation of the pump.

Other features will be in part apparent and in part pointed out hereinafter.

### BRIEF DESCRIPTION OF THE DRAWINGS

FIG. 1 is a schematic illustration showing a perspective view of an enteral feeding pump and a fragmentary portion of a feeding set received on the pump;

FIG. 2 is a schematic illustration showing a perspective view of the feeding pump of FIG. 1, with a cassette housing of the feeding set removed;

FIG. 3 is a schematic illustration of the feeding pump showing perspective view of FIG. 1, with the feeding set removed;

FIG. 4 is a graph of an acceleration profile produced by a sensor of the pump; and

FIG. 5 is a block diagram schematically showing certain components of the enteral feeding pump.

Corresponding reference characters indicate corresponding parts throughout the several views of the drawings.

### DETAILED DESCRIPTION

In a first aspect, an enteral feeding pump for mounting a pump set for enteral delivery of fluid through the pump set to a subject generally comprises a housing capable of receiving at least a portion of a pump set. A pumping device contacts the pump set when the pump set is received by the housing so the pumping device acts on the pump set to produce fluid flow in the pump set for enteral delivery of fluid to a subject. A sensor is connected to the housing for sensing acceleration of at least a portion of the housing caused by an impact to the housing and producing a signal in response to the sensed acceleration. A control circuit in the housing is configured to perform an operation after the sensor produces a predetermined sequence of signals. The control circuit can be configured to recognize the predetermined sequence of signals and associate it with the operation. The control circuit can be configured to recognize other predetermined sequences of signals and associate them with other operations of the pump. The predetermined sequence of signals can comprise a series of amplitude spikes in a sensor output. The pump can further comprise lighting, wherein the control circuit is configured to associate a first sequence of impacts on the housing with a command to activate the lighting. The control circuit can be configured to associate a second sequence of impacts on the housing with a command to de-activate the lighting. The control circuit can be configured to de-activate the lighting after a predetermined period of time following activation of the lighting. The pump can further comprise a display for displaying information about the pump and at least one light for illuminating the display, where the control circuit is configured to illuminate the display when the sensor produces the predetermined signal. The control circuit can be configured to suspend operation of the pump if the sensor senses acceleration above a predetermined threshold. The sensor can be an accelerometer. The control circuit can include a memory and a processor, wherein the processor can store in the memory sensor signals indicative of acceleration over a predetermined threshold as critical impact events and the processor can be programmed to perform an analysis of pump operation including retrieving stored critical impact events for analysis as a source of operational error.

In another aspect, a pumping apparatus for use with a pump set to deliver fluid through the pump set generally comprises a housing capable of receiving at least a portion of a pump set. The pumping device contacts the pump set when the pump set is received by the housing so the pumping device acts on the pump set to produce fluid flow in the pump set to deliver fluid to a subject. A sensor is connected to the housing for sensing acceleration of at least a portion of the housing a signal in response to the sensed acceleration. A display displays information about the pump. At least one light illuminates the display. The apparatus is typically programmed to illuminate the display when the sensor produces a predetermined signal. The apparatus is typically programmed to illuminate the display for a set period. The predetermined signal is produced by an acceleration sequence. The acceleration sequence can comprise a series of amplitude spikes in the signal produced by the sensor within a given period. The apparatus is programmed to suspend operation of the apparatus if the sensor senses acceleration above a predetermined threshold. The sensor is typically an accelerometer.

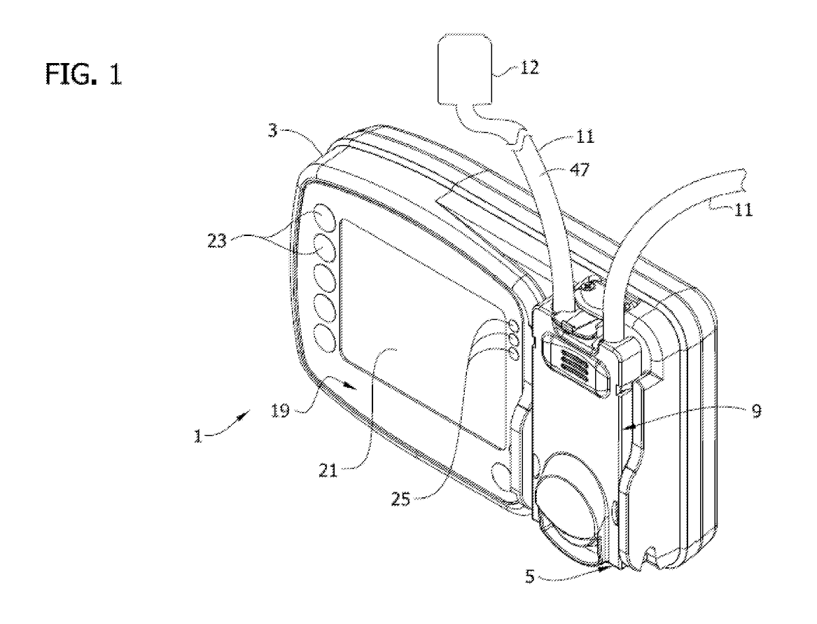

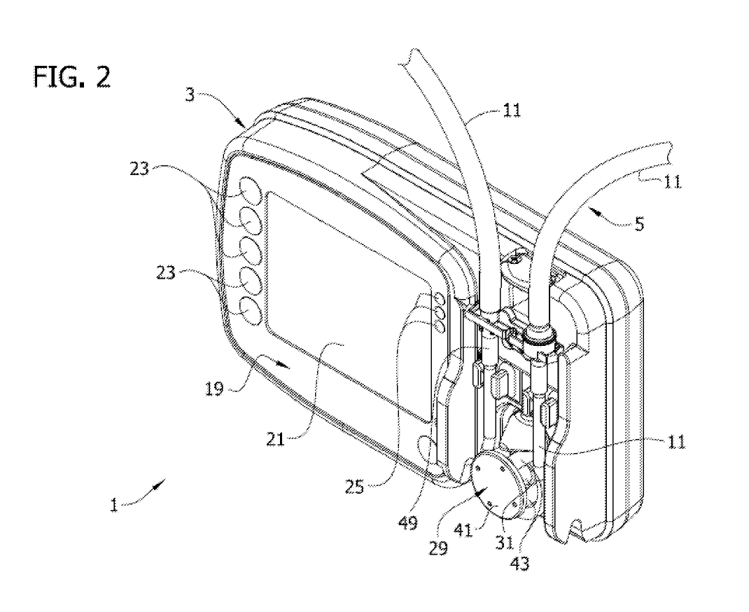

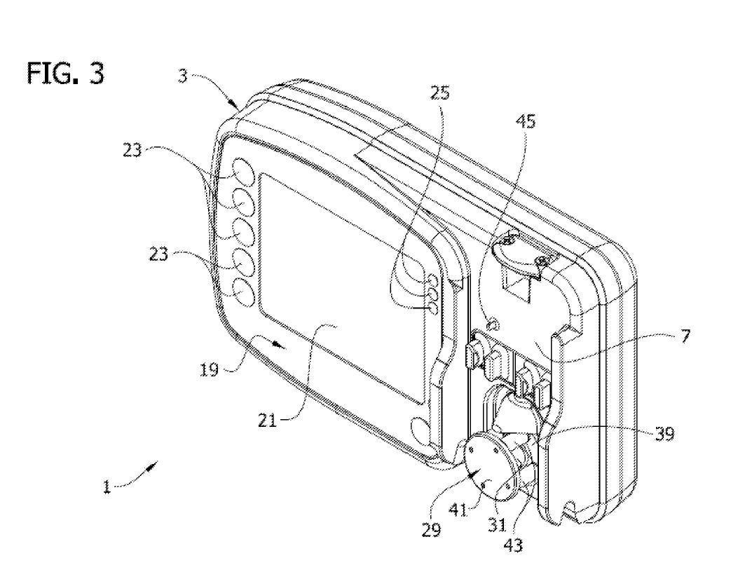

Referring now to the exemplary embodiment schematically illustrated in FIGS. 1-3, an enteral feeding pump (broadly, “a flow control apparatus”) is generally indicated at 1. The pump 1 may comprise a housing 3 that is constructed to allow an administration feeding set 5 (broadly, “a pump set”) to be mounted to the housing. The housing 3 may comprise a recess 7 (FIG. 3) for receiving a cassette 9 of the feeding set 5 to load the feeding set on the pump. The administration feeding set 5 can comprise tubing indicated generally at 11 that provides a fluidic pathway between a bag 12 of nutritional liquid (broadly, “a feeding fluid source”) and a patient (FIG. 1). The tubing 11 may also provide a fluidic pathway between a second bag (not shown) of flushing liquid (broadly, “a flushing liquid source”) and the patient. In one embodiment, the flushing fluid may be water. The cassette 9 may mount the tubing 11 for engaging the tubing with the pump 1 when the cassette is received in the recess 7. It will be understood that a pump set may have a construction other than shown herein. For example, a pump set (not shown) may not include the cassette as illustrated herein.

As used herein, the term “load” means to connect or mount so that at least a portion of the tubing 11 is engaged with the pump 1 so that the administration feeding set 5 is operatively configured or coupled with the pump to deliver fluid to a patient. It will be appreciated that the term “housing,” as used herein, may include many forms of supporting structures including, without limitation, multi-part structures and structures that do not enclose or contain one or more of the working components of the pump 1.

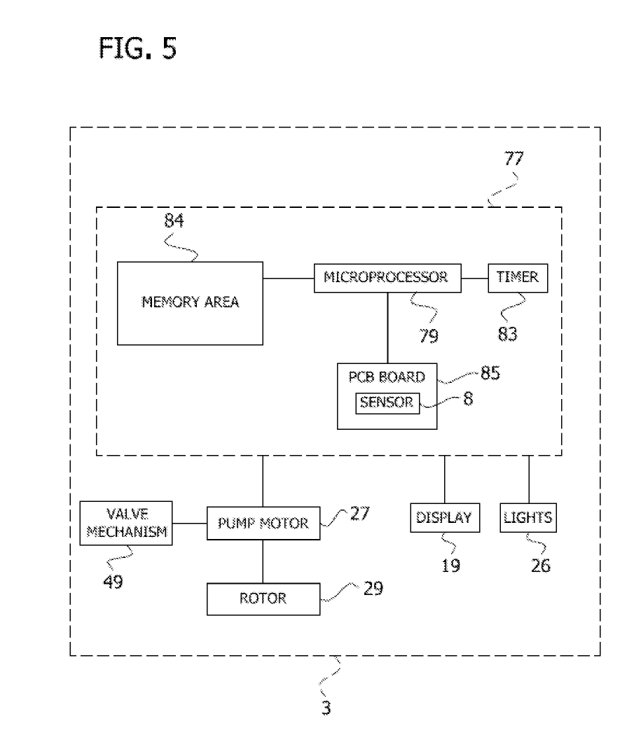

The pump can have one or more sensors that monitor one or more conditions or activities or external events pertinent to the pump. For example, the pump can have an acceleration sensor 8, which may be mounted in the housing 3 (FIG. 5). For instance, the sensor 8 may be mounted at a bottom of the pump 1. However, the sensor 8 could be disposed at a different location. Although other acceleration sensors may be used, in one embodiment the sensor is an accelerometer. The accelerometer may detect motion along any one or more of the x-, y-, and z-axes, and rotation about any one or more of the x-, y-, and z-axes for detecting motion in at least six degrees of freedom. A sensor capable of detecting fewer than all of the aforementioned motions may be used. It should be understood that other sensors such as an impact switch can be used with or in place of the accelerometer. Any number of sensors can be used to detect acceleration in a desired direction. Non-limiting examples of the acceleration sensor include sensors that are commercially available from Kionix, Inc., Ithaca, N.Y.

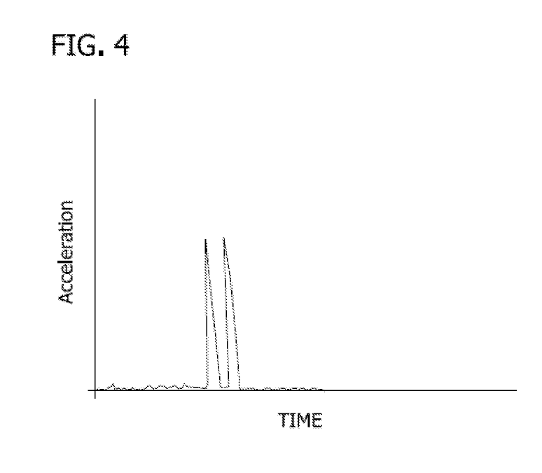

The sensor 8 can detect movement, acceleration, vibration, and impact of the pump 1 and produce an electrical signal in response to the detected movement. An example of the electrical signal is shown in FIG. 4 where the signal is plotted as acceleration over time. Because the sensor 8 can detect acceleration in at least six degrees of freedom, an acceleration reading can be produced for directions along and about each of the x-, y-, and z-axes. As will be explained in detail below, the pump 1 may be configured to perform certain operations based on the signal produced by the sensor 8.

The pump 1 may include a user interface 19 with one or more display screens indicated at 21 on, for example, the front of the housing 3 that is capable of displaying information about any one or more of the status and operation of the pump. The pump 1 can further comprise one or more buttons 23 and one or more visible indicators, such as light emitting diodes 25, on the housing 3 for use with the display screen 21 to facilitate exchanging information, such as providing and obtaining information, between the pump 1 and a user. One or more light sources or lights 26 (FIG. 5) can be disposed or configured in the housing 3 to illuminate at least a portion the display screen 21. Various user interfaces for displaying information to the user and receiving user input may be implemented. Any of the various configurations of the user interface can involve utilizing one or more graphical display subcomponents. As an example, the display screen 21 may be a graphical user interface having a touch screen by which the user can provide the input information. In other embodiments, the user interface can be a tethered component that can be used to provide input information, provide operating information pertaining to the flow control apparatus, or both. Other light sources (not shown) may also be included to illuminate any one or more of at least a portion of the bag and the feeding set 5, the cassette 9, and tubing 11 such as the portion of the tubing engaged with the pumping device described below.

It should be understood that although the illustrated pump 1 is an enteral feeding pump, the various features and advantages may be implemented on other types of peristaltic pumps (not shown), including medical infusion pumps. The general construction and operation of the enteral feeding pump 1, except as set forth hereinafter, may be generally the same as disclosed in co-assigned U.S. Pat. No. 7,462,170 filed May 24, 2004, entitled ADMINISTRATION FEEDING SET AND VALVE MECHANISM; U.S. Pat. No. 7,608,059 filed May 24, 2004, entitled FLOW CONTROL APPARATUS; U.S. Pat. No. 7,092,797 filed May 25, 2004, entitled FLOW MONITORING SYSTEM FOR A FLOW CONTROL APPARATUS; and U.S. Pat. No. 7,534,009 filed Sep. 30, 2005, entitled ALIQUOT CORRECTION FOR FEEDING SET DEGRADATION, the disclosures of each of which is incorporated by reference for the purpose of disclosing exemplary peristaltic pump operation.

Referring to FIGS, 2, 3, and 5, the pump 1 may include a pump motor 27 (FIG. 5) located in the housing 3. A pump rotor 29 may be mounted on a rotatable shaft 31 and rotated by the motor 27. In one embodiment, the pump rotor 29 includes an inner disk 39, an outer disk 41, and preferably a plurality of rollers 43 mounted between the inner and outer disks rotatable about their longitudinal axes relative to the disks. The motor 27 may also be connected to a valve shaft 45 (FIG. 3). It will be understood that the valve shaft 45 could be omitted, or a separate motor (not shown) could be provided to operate the valve shaft. The rollers 43 may engage the administration feeding set 5 for moving fluid through the feeding set. In the illustrated embodiment, the pump motor 27, rotatable shaft 31, rotor 29, and valve shaft 45 may broadly be considered “a pumping device”. It will be understood that peristaltic pumps that use mechanisms other than rollers may utilize any one or more of the features disclosed herein. For example, one or more of the features disclosed herein may be used in a linear peristaltic pump.

Referring now to FIGS. 1, 2 and 4, the tubing 11 of the administration feeding set 5 provides a fluid pathway between at least one source of fluid and a patient. In the illustrated embodiment, the tubing 11 provides a fluid pathway for the fluid source 12. A first inlet tube section 47 is connected at an inlet of the tubing 11 to source 12 of feeding fluid and to valve mechanism 49. Optionally a second inlet tube section (not shown) is connected at an inlet of the tubing 11 to a second source fluid, e.g., flushing fluid, and to the valve mechanism. The valve mechanism 49 can be operable to selectively permit flow of feeding fluid from the first source or flushing fluid from the second source, or prevent any fluid flow communication from the first and second sources past the valve mechanism. Thus, for example, the valve mechanism 49 can be turned to three positions. The first closes off all fluid flow from the inlet tube sections past the valve mechanism, the second allows feeding fluid to flow from the first source past the valve mechanism, and a third allows flushing fluid to flow from the second source past the valve mechanism.

The pump 1 can be programmed or otherwise controlled to operate as desired. For instance, the pump 1 can begin operation to provide feeding fluids from the bag 12 to the patient. The user or caregiver may select by entering on the user interface (for example) the amount of fluid to be delivered, the rate at which the fluid is to be delivered, and the frequency of fluid delivery. The pump 1 may have a controller 77 (see FIG. 5) including a processor or microprocessor 79 that allows it to accept programming and/or to include or execute operational routines that can be initiated by the caregiver. The controller 77 (broadly, “a control circuit”) may also include a timer 83 and a memory device with a memory area 84.

In one configuration, the control circuit is in communication with the one or more sensors 8 for detecting the amount of acceleration of the pump 1. In the illustrated embodiment, the sensor 8 is mounted on a PCB board 85 which is disposed to receive any external events or actions on the housing, e.g., a movement of the housing, and is further operatively connected to the microprocessor 79 so that a signal produced by the sensor in response to external event, e.g., the movement of the pump is communicated to the microprocessor. In further configurations, the sensor 8 enables the pump 1 to monitor impacts on the pump, e.g., the housing, throughout the course of pump operation. For example, data from the sensor 8 can be used to assist with trouble shooting of the pump 1, to assess whether a violation of warranty exclusions may have occurred, and to warn a user of potential misuse or extreme use of the pump. The microprocessor 79 may be programmed to execute instructions for controlling operation of the pump 1 in response the signal received from the sensor 8.

In some cases, the control circuit is configured to receive the signal and identify or determine the classification of the signal or a plurality of signals and control operation or activate one or more components of the pump in response to the signal or plurality of signals.

For example, the microprocessor 79 may be configured, e.g., programmed, to execute instructions that identify or recognize a predetermined threshold level of acceleration and/or a predetermined sequence of acceleration (i.e., an acceleration profile or acceleration event) and perform certain operations of the pump 1 in response to the identified or detected acceleration or event. In one embodiment, the microprocessor 79 may turn off or suspend operation of the pump 1 if the sensor 8 detects acceleration, e.g., an event, which is above a predetermined threshold indicating that a substantial impact has occurred such as dropping the pump on a hard surface, e.g., a critical impact. Data associated with the event and any data associated with any currently executed operating conditions of the pump can be stored in the memory area 84 for future assessment by a clinician or technician. The data may be stored in the memory area 84 to be retrieved by the microprocessor 79 for analysis as a source of operational error. Such data can be used to determine whether continued use of the pump 1 is appropriate, e.g., whether the pump can still be used without repair or service, whether the pump can be used without re-certification, whether the operating activity of the pump when the event occurred is valid or whether the operating activity must be re-performed. In one embodiment, a critical impact can involve a collision such as dropping the pump on a hard surface from a height of two feet or greater. In other cases, the critical impact can be an event involving dropping the pump on a hard surface from a height of three feet or greater. The determination of the threshold, e.g., the predetermined threshold, will be dependent on pump components design as well as the materials of construction of such components.

In one configuration, the control circuit is configured to receive the signal and perform or control an operation in response to a predetermined sequence of impacts detected by the sensor 8. In one instance, the microprocessor 79 may receive the signal and identify whether the acceleration event corresponds to a series of impacts on the housing resulting from a user tapping the housing. For example, the user may tap in twice within a short duration, e.g., within less than one second, to provide a command signal for an operation of the pump or component thereof. In one configuration, for example, the command signal may be a light-activating signal to the energize or illuminate the lights 26 in the housing 3 in response to a series of abrupt spikes in acceleration consistent with the action of a user “double tapping” the housing (FIG. 4). This allows, for example, illumination of at least a portion of the display screen 21 in a dark room without having to locate the buttons 23 on the housing 3. It also reduces the likelihood the user will unintentionally hit the buttons 23 in a manner that may undesirably affect the pump operation. The control circuit may further be configured to illuminate the lights 26 for a preset period (e.g., 15 seconds) to allow the user to operate the pump 1 as needed. After the preset period, the control circuit can be configured to turn off or de-energize at least one or more of the lights 26. The de-energizing procedure may be, in some cases, in response to another signal associated with a sequence of impacts detected by the sensor 8, e.g., a light-deactivating signal. The sequence of acceleration to turn off the lights 26 may be the same or different from the sequence to illuminate the lights. Predetermined acceleration sequences other than the “double tap” sequence are also envisioned. By identifying a predetermined acceleration sequence, the control circuit can be configured to identify or differentiate between acceleration intended to instruct operation of the pump 1 and acceleration resulting from random movement or other operations of the pump. Thus, for example, the control circuit can be configured to compare the magnitude of the signal or sequence of signals to, for example, one or more reference magnitudes of acceleration events stored in the memory to determine whether the received signal or sequence or signals is congruent to a valid command signal rather than noise or false acceleration events. In one or more configurations, for example, the comparison can involve confirmation that the received signal or sequence of signals is within an acceptable threshold sensitivity, e.g., within 90% of the magnitude of the stored acceleration value to be considered a valid command signal.

In one embodiment, the control circuit may be configured to identify or recognize an acceleration sequence indicative of continued motion of the pump 1 consistent with the pump being used while a subject is ambulating. The acceleration sequence can be stored in the memory area 84 of the controller 77. By recognizing when the pump 1 is used during ambulation, e.g. for at least a predetermined signal reception period, the microcontroller 79 can instruct the controller 77 to alter operation of the pump to compensate or optimize pump performance. For example, if the sequence of signals occurs for a duration of at least about one minute, the microprocessor may send one or more signals to increase the pump flow rate by a predetermined factor, e.g., by at least about 5%, during the detected motion. Further, in other cases, the altered operation procedure may be initiated after threshold duration of continued motion is detected, e.g., for at least about fifteen minutes. The predetermined factor may be at other values sufficient to adjust or compensate for a change in flow rate accuracy resulting from a reduced head height, which is defined as a deviation from a prescribed or intended elevation of the fluid source above the top of the pump. The head height, for example, can be predetermined to be about ten inches and deviation from the predetermined elevation can be implied as associated with the ambulatory event or ambulatory status because the fluid source would be expected to be contained in a pouch that also contains the pump.

In one embodiment, the signal from the sensor can provide an indication of an orientation of the pump, which can be utilized by the control circuit which in turn can control operation of the display, based on the orientation. For example, the sensor can provide an indication that the pump is in a first upright position, as schematically depicted in the perspective view of FIG. 1. The sensor can thus generate a signal associated with the first upright orientation and accordingly generate and send control signals to the display to present information regarding the pump or the pump parameters for viewing by the patient or user on the display in an upright display configuration. The sensor can further provide an indication that the pump is in a second upright position, orthogonal to the orientation depicted in FIG. 1. The sensor can thus generate a second signal associated with the second upright orientation and accordingly generate and send control signals to the display to present information regarding the pump or the pump parameters for viewing by the patient or user on the display in a second upright display configuration. In a particular example, the first orientation can be presenting in the portrait configuration and the second orientation can be presenting in a landscape configuration. In further arrangements, the sensor can monitor the pump orientation and send such corresponding orientation related signals periodically, e.g., once every second, to the control circuit. In still further arrangements, the sensor, or the control circuit can isolated from changing the orientation upon entry of a command by the patient or user which would prevent any changes to the presentation orientation of the display. In yet further configurations, the sensor can further provide an indication that the pump is in a third upright position, 180° relative to the orientation depicted in the perspective view of FIG. 1. The sensor can thus generate a third signal associated with the second upright orientation and accordingly generate and send control signals to the display to present information regarding the pump or the pump parameters for viewing by the patient or user on the display in a third upright display configuration. In the third orientation, however, the control circuit may be further configured to optionally generate a notification, such as any one or more of providing a local visible indication, e.g., on the display, generating a local audible alarm, and transmitting the notification to a remote monitoring facility, that the pump is not in a proper or preferred operating orientation. The notification may, in some cases, be automatically disabled, if the sensor further provides a plurality of signals that the control circuit would identify or determine as corresponding to an ambulatory event.

The presently disclosed advantages and features may be described in the general context of computer-executable instructions, such as program modules, executed by one or more computers or other devices. The computer-executable instructions may be organized into one or more computer-executable components or modules including, but not limited to, routines, programs, objects, components, and data structures that perform particular tasks or implement particular abstract data types. Any one or more aspects or embodiments may be implemented with any number and organization of such components or modules. For example, aspects are not limited to the specific computer-executable instructions or the specific components or modules illustrated in the figures and described herein. Other embodiments may include different computer-executable instructions or components having more or less functionality than illustrated and described.

Further, the order of execution or performance of the operations illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope.

Microprocessor 79 of the controller 77 may execute computer-executable instructions such as those illustrated in the figures to implement any of the disclosed features. Any of the features may also be practiced in distributed computing environments where tasks are performed by remote processing devices linked through a communications network. In a distributed computing environment, program modules may be located in both local and remote computer storage media including non-transitory memory storage devices.

Further any of the various features and aspects can be directed to providing an enteral feeding pump having a housing configured to have a pump set mounted thereon for delivery of a fluid to a subject. The method can comprise providing a pumping device configured to act on the pump set to produce fluid flow through the pump set, connecting a sensor to the housing, wherein the sensor is configured to sense an acceleration of the housing and produce one or more signals in response to the acceleration of the housing, and operatively coupling a control circuit to the housing, wherein the control circuit is configured to perform an operation in response to the one or more signals or to a predetermined sequence of signals. Further variants can involve modifying a pump apparatus to incorporate at least one sensor configured to detect an acceleration of the pump apparatus, or a portion thereof, and generate one or more signals representative of one or more detected accelerations or motions, and modifying a controller of the pump apparatus to receive the one or more signals and control operation of the pump apparatus based on the one or more signals. Still further aspects can be directed to computer-readable media having instructions stored thereon that are readable by a processor wherein the instructions regulate operation of a pump apparatus based on at least one signal from an acceleration sensor.

Further features can be directed to a computer-readable medium having stored thereon processor executable instruction involving a method of operation of the pump to effect fluid flow through a feeding set operably coupled to the pump. The method can comprise receiving a signal from a sensor that is representative of an acceleration event of the pump, comparing the signal to a predetermined reference to determine or identify if the signal corresponds to a command signal, operating or controlling operation of the pump or a component of the pump based on the command signal. Alternatively or optionally, the instructions can be directed to a method that includes steps of identifying whether the signal corresponds to an acceleration associated with a critical impact of the pump, and suspending operation of the pump upon identification of the critical impact event. Alternatively or optionally, the instructions can be directed to a method that includes steps of identifying whether the signal or sequence of signals corresponds to continued movement of the pump or an ambulatory condition, and compensating or adjusting the pump operating parameters increase the pump flow rate by a predetermined amount.

When introducing elements or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements. Moreover, the use of “up”, “down”, “top”, and “bottom” and variations of these terms is made for convenience, but does not require any particular orientation of the components.

As various changes could be made in the above without departing from the scope, it is intended that all matter contained in the above description and shown in the accompanying drawings shall be interpreted as illustrative and not in a limiting sense.

1.-16. (canceled)

17. An enteral feeding pump for mounting a pump set for enteral delivery of fluid through the pump set to a subject, the enteral feeding pump comprising:
a housing capable of receiving at least a portion of the pump set;
a display in the housing for displaying information about the pump;
a pumping device contacting the pump set when the pump set is received by the housing so the pumping device acts on the pump set to produce fluid flow in the pump set;
a sensor connected to the housing for sensing an acceleration of at least a portion of the housing and producing a signal in response to the sensed acceleration; and
a control circuit configured to receive the signal and control operation of the pump in response to the signal.

18. The pump as set forth in claim 17, wherein the control circuit is configured to identify the signal as corresponding to a predetermined event and control operation of the pump with the predetermined event.

19. The pump as set forth in claim 17, wherein the control circuit is further configured to suspend operation of the pump if a magnitude of the acceleration is above a predetermined threshold.

20. The pump as set forth in claim 17, further comprising an illumination source (26), and wherein the control circuit is configured to identify the signal as a light-activating signal, and wherein operation of the pump comprises energizing the illumination source upon identification of the light-activating signal.

21. The pump as set forth in claim 20, wherein the control circuit is further configured to interpret a second signal produced by the sensor from a second acceleration as a light-deactivating signal, and wherein operation of the pump further comprises de-energizing the illumination source upon identification of the light-deactivating signal.

22. The pump as set forth in claim 20, wherein the control circuit is further configured to de-energize the illumination source after a predetermined period, after energizing the illumination source.

23. The pump as set forth in claim 20, wherein the illumination source is configured to illuminate at least a portion of the display.

24. The pump as set forth in claim 20, wherein the control circuit includes a processor and a memory having stored therein a representative signal indicative of acceleration as a critical impact, the processor configured to perform instructions that compare the received signal to the representative signal and identify the acceleration as a critical impact, and, upon identification of the critical impact, provide an indication of an operational error.

25. The pump as set forth in claim 20, wherein the control circuit is configured to identify the signal as corresponding to ambulatory activity, and to control operation of the pump based on a duration of the ambulatory activity.

26. The pump as set forth in claim 17, wherein the control circuit is configured to identify the signal as corresponding to ambulatory activity, and to control operation of the pump based on a duration of the ambulatory activity.

27. The pump as set forth in claim 17, wherein the control circuit is configured to identify the signal as corresponding to an orientation of the pump, and to control operation of the display based on the orientation of the pump.

28. A method of fabricating a pump having a housing configured for mounting a pump set thereonto for enteral delivery of fluid through the pump set to a subject, and a display for indicating information about the pump, the method comprising:
connecting a sensor to the housing for sensing an acceleration of at least a portion of the housing and producing a signal in response to the sensed acceleration;
connecting a control circuit to the sensor to receive the signal, wherein the control circuit is configured to the control operation of the pump based on the received signal.

29. The method as set forth in claim 28, wherein the control circuit is further configured to identify whether the signal corresponds to an illumination command, and the control circuit is further configured to illuminate at least a portion of the display upon identification of the illumination command.

30. The method as set forth in claim 28, wherein the control circuit is further configured to identify whether the signal corresponds to a critical impact, and wherein the control circuit is configured to suspend operation of the pump upon identification of the critical impact.

31. The method as set forth in claim 30, wherein the control circuit is further configured to identify whether the signal corresponds to a critical impact, and wherein the control circuit is configured to suspend operation of the pump upon identification of the critical impact.

32. The method as set forth in claim 28, wherein the control circuit is configured to identify whether the signal corresponds to ambulatory activity, and to regulate operation of the pump based on a duration of the ambulatory activity.

33. The method as set forth in claim 28, wherein the control circuit is configured to identify the signal as corresponding to an orientation of the pump, and to control operation of the display based on the orientation of the pump.
